(19) United States
(12) Patent Application Publication
(10) Pub. No.: US 2024/0237106 A1
(43) Pub. Date: Jul. 11, 2024

(54) SYSTEM AND METHOD OF SECONDARY CELL GROUP (SCG) ACTIVATION

(71) Applicant: SAMSUNG ELECTRONICS CO., LTD., Suwon-si, Gyeonggi-do (KR)

(72) Inventors: Anil AGIWAL, Suwon-si (KR); Jaehyuk JANG, Suwon-si (KR)

(21) Appl. No.: 18/559,295

(22) PCT Filed: May 6, 2022
(86) PCT No.: PCT/KR2022/006474

§ 371 Date: Nov. 6, 2023

(30) Foreign Application Priority Data
May 6, 2021 (KR) 10-2021-0058747

(51) Int. Cl. H04W 76/15; H04B 17/318; H04W 72/1273; H04W 76/20

(52) U.S. Cl. CPC H04W 76/15; H04B 17/328; H04W 72/1273; H04W 76/20

(57) ABSTRACT

The disclosure provides a method performed by a UE in a wireless communication system supporting a dual connectivity. The method includes identifying that a secondary cell group (SCG) is deactivated, receiving first information on a transmission configuration information (TCI) state for a primary secondary cell (PSCell), and receiving second information for activating the SCG, wherein the TCI state is activated for a physical downlink control channel (PDCCH) or a physical downlink shared channel (PDSCH) on the PSCell of the SCG activated based on the second information.

### TECHNICAL FIELD

The disclosure relates to operations of a user equipment (UE) and a base station (BS) in a wireless communication system. More particularly, the disclosure relates to method of secondary cell group (SCG) activation/deactivation.

### BACKGROUND ART

Fifth generation (5G) mobile communication technologies define broad frequency bands such that high transmission rates and new services are possible, and can be implemented not only in “Sub 6 GHz” bands such as 3.5 GHZ, but also in “Above 6 GHZ” bands referred to as mmWave including 28 GHZ and 39 GHz. In addition, it has been considered to implement sixth generation (6G) mobile communication technologies (referred to as Beyond 5G systems) in terahertz bands (for example, 95 GHz to 3 THZ bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive Multiple-Input Multiple-Output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of Bandwidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random-access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultrahigh-performance communication and computing resources.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

The disclosure relates to operations of a user equipment (UE) and a base station (BS) in a wireless communication system. More particularly, the disclosure relates to method of secondary cell group (SCG) activation/deactivation.

An aspect of the disclosure is to provide a method and apparatus for determining whether to perform a random access procedure upon activation of the SCG.

Another aspect of the disclosure is to provide a method and an apparatus for determining which BWP will be used in case that a deactivated SCG is activated.

Another aspect of the disclosure is to provide a method and an apparatus for determining TCI state to be used/activated for PDCCH/PDSCH on PSCell, upon activation of the SCG.

Additional aspects will be set forth in part in the description which follows and, in part, will be apparent from the description, or may be learned by practice of the presented embodiments.

### Solution to Problem

In accordance with an aspect of the disclosure, a method performed by a user equipment (UE) in a wireless communication system supporting a dual connectivity is provided. The method includes identifying that a secondary cell group (SCG) is deactivated, receiving first information on a transmission configuration information (TCI) state for a primary secondary cell (PSCell), and receiving second information for activating the SCG, wherein the TCI state is activated for a physical downlink control channel (PDCCH) or a physical downlink shared channel (PDSCH) on the PSCell of the SCG activated based on the second information.

In accordance with another aspect of the disclosure, a method performed by a master node in a wireless communication system supporting a dual connectivity is provided. The method includes identifying that a secondary cell group (SCG) is deactivated, transmitting, to a user equipment (UE), first information on a transmission configuration information (TCI) state for a primary secondary cell (PSCell), and transmitting, to the UE, second information for activating the SCG, wherein the TCI state is activated for a physical downlink control channel (PDCCH) or a physical downlink shared channel (PDSCH) on the PSCell of the SCG activated based on the second information.

In accordance with another aspect of the disclosure, a method performed by a secondary node in a wireless communication system supporting a dual connectivity is provided. The method includes identifying that a secondary cell group (SCG) is deactivated, transmitting, to a master node, first information on a transmission configuration information (TCI) state for a primary secondary cell (PSCell), and transmitting, to the master node, second information for activating the SCG, wherein the TCI state is activated for a physical downlink control channel (PDCCH) or a physical downlink shared channel (PDSCH) on the PSCell of the SCG activated based on the second information.

In accordance with another aspect of the disclosure, a user equipment (UE) in a wireless communication system supporting a dual connectivity is provided. The UE includes a transceiver, and a processor coupled with the transceiver. The processor is configured to identify that a secondary cell group (SCG) is deactivated, receive first information on a transmission configuration information (TCI) state for a primary secondary cell (PSCell), and receiving second information for activating the SCG, wherein the TCI state is activated for a physical downlink control channel (PDCCH) or a physical downlink shared channel (PDSCH) on the PSCell of the SCG activated based on the second information.

In accordance with another aspect of the disclosure, a master node in a wireless communication system supporting a dual connectivity is provided. The master node includes a transceiver, and a processor coupled with the transceiver. The processor is configured to identify that a secondary cell group (SCG) is deactivated, transmit, to a user equipment (UE), first information on a transmission configuration information (TCI) state for a primary secondary cell (PSCell), and transmit, to the UE, second information for activating the SCG, wherein the TCI state is activated for a physical downlink control channel (PDCCH) or a physical downlink shared channel (PDSCH) on the PSCell of the SCG activated based on the second information.

In accordance with another aspect of the disclosure, a secondary node in a wireless communication system supporting a dual connectivity is provided. The master node includes a transceiver, and a processor coupled with the transceiver. The processor is configured to identify that a secondary cell group (SCG) is deactivated, transmit, to a master node, first information on a transmission configuration information (TCI) state for a primary secondary cell (PSCell), and transmit, to the master node, second information for activating the SCG, wherein the TCI state is activated for a physical downlink control channel (PDCCH) or a physical downlink shared channel (PDSCH) on the PSCell of the SCG activated based on the second information.

Other aspects, advantages, and salient features of the disclosure will become apparent to those skilled in the art from the following detailed description, which, taken in conjunction with the annexed drawings, discloses various embodiments of the disclosure.

### Advantageous Effects of Invention

According to an embodiment of the disclosure, upon activation of the SCG, whether to perform a random access procedure can be determined. In addition, it is possible to reduce the latency required for SCG activation by providing a criterion for whether to perform the random access procedure.

According to an embodiment of the disclosure, it can decide which BWP will be used in case that a deactivated SCG is activated.

According to an embodiment of the disclosure, it can decide which TCI state will be used/activated for PDCCH/PDSCH on PSCell, upon activation of the SCG.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates an example of secondary node (SN) addition procedure according to an embodiment of the disclosure;

FIG. 2 illustrates an example of a UE operation related to RACH trigger upon SCG activation according to an embodiment of the disclosure;

FIG. 3 illustrates another example of the UE operation related to RACH trigger upon SCG activation according to an embodiment of the disclosure;

FIG. 4 illustrates an example of a signaling flow for activating/updating a TCI state for deactivated SCG according to an embodiment of the disclosure;

FIG. 5 illustrates another example of a signaling flow for activating/updating a TCI state for deactivated SCG according to an embodiment of the disclosure;

FIG. 6 illustrates a structure of a UE according to an embodiment of the disclosure; and

FIG. 7 illustrates a structure of a base station according to an embodiment of the disclosure.

Throughout the drawings, it should be noted that like reference numbers are used to depict the same or similar elements, features, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Before undertaking the detailed description below, it can be advantageous to set forth definitions of certain words and phrases used herein. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A and B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments are not intended to limit and/or define the scope of the disclosure. For example, unless otherwise defined, the technical terms or scientific terms used in the disclosure shall have the ordinary meaning understood by those with ordinary skills in the art to which the disclosure belongs.

It should be understood that “first”, “second” and similar words used in the disclosure do not express any order, quantity or importance, but are only used to distinguish different components. Unless otherwise indicated by the context clearly, similar words such as “a”, “an” or “the” in a singular form do not express a limitation of quantity, but express an existence of at least one.

As used herein, any reference to “one example” or “example”, and “one embodiment” or “embodiment” means that particular elements, features, structures or characteristics described in connection with the embodiment is included in at least one embodiment. The phrases “in one embodiment” or “in one example” appearing in different places do not necessarily refer to the same embodiment.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

In the description of the disclosure, when it is considered that some detailed explanations about functions or configurations may unnecessarily obscure the essence of the disclosure, these detailed explanations will be omitted. All terms (including descriptive or technical terms) used herein should be interpreted as having meanings apparent to those of ordinary skill in the art. However, these terms may have different meanings according to the intention of those of ordinary skill in the art, precedents or the emergence of new technologies, and therefore, the terms used herein must be defined based on the meanings of these terms together with the description provided herein.

Hereinafter, for example, the base station may be at least one of a gNode B, an eNode B (eNB), a Node B, a radio access unit, a base station controller, and a node on a network. The terminal may include a user equipment (UE), a mobile station (MS), a mobile phone, a smart phone, a computer or multimedia system capable of performing communication functions. In some embodiments of the disclosure, the downlink (DL) is a wireless transmission path through which signals are transmitted from a base station to a terminal, and the uplink (UL) is a wireless transmission path through which signals are transmitted from a terminal to a base station.

The various embodiments discussed below for describing the principles of the disclosure herein are for illustration purposes only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to 5G, those skilled in the art can understand that the main points of the disclosure can also be applied to other communication systems (for example, beyond 5G (B5G) or 6G) with similar technical backgrounds and channel formats with slight modifications without departing from the scope of the disclosure.

Hereinafter, the embodiments of the disclosure will be described in detail with reference to the accompanying drawings. It should be noted that the same reference numerals in different drawings will be used to refer to the same elements already described.

### Random Access in Fifth Generation Wireless Communication System:

In the 5G wireless communication system, random access (RA) is supported. Random access (RA) is used to achieve uplink (UL) time synchronization. RA is used during initial access, handover, radio resource control (RRC) connection reestablishment procedure, scheduling request transmission, secondary cell group (SCG) addition/modification, beam failure recovery and data or control information transmission in UL by non-synchronized UE in RRC CONNECTED state. Several types of random access procedure is supported such as contention based random access, contention free random access and each of these can be one 2 step or 4 step random access.

### PDCCH in Fifth Generation Wireless Communication System:

In the 5G wireless communication system, Physical Downlink Control Channel (PDCCH) is used to schedule downlink (DL) transmissions on physical downlink shared channel (PDSCH) and UL transmissions on physical uplink shared channel (PUSCH), where the Downlink Control Information (DCI) on PDCCH includes: Downlink assignments containing at least modulation and coding format, resource allocation, and hybrid-ARQ information related to DL-SCH; Uplink scheduling grants containing at least modulation and coding format, resource allocation, and hybrid-ARQ information related to UL-SCH. In addition to scheduling, PDCCH can be used to for: Activation and deactivation of configured PUSCH transmission with configured grant; Activation and deactivation of PDSCH semi-persistent transmission; Notifying one or more UEs of the slot format; Notifying one or more UEs of the physical resource block(s) (PRB)(s) and orthogonal frequency-division multiplexing (OFDM) symbol(s) where the UE may assume no transmission is intended for the UE; Transmission of transmit power control (TPC) commands for PUCCH and PUSCH; Transmission of one or more TPC commands for sounding reference signal (SRS) transmissions by one or more UEs; Switching a UE's active bandwidth part; Initiating a random access procedure.

A UE monitors a set of PDCCH candidates in the configured monitoring occasions in one or more configured Control REsource SETs (CORESETs) according to the corresponding search space configurations. A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own DMRS. QPSK modulation is used for PDCCH.

In 5G wireless communication system, a list of search space configurations is signaled by gNB for each configured BWP of serving cell wherein each search configuration is uniquely identified by a search space identifier. Search space identifier is unique amongst the BWPs of a serving cell. Identifier of search space configuration to be used for specific purpose such as paging reception, SI reception, random access response reception is explicitly signaled by gNB for each configured BWP. In NR search space configuration comprises of parameters Monitoring-periodicity-PDCCH-slot, Monitoring-offset-PDCCH-slot, Monitoring-symbols-PDCCH-within-slot and duration. A UE determines PDCCH monitoring occasion (s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration where the slot with number ‘x’ in a radio frame with number ‘y’ satisfies the equation below:

$$( {y}^{*} ( number of slots in a radio frame ) + x - Monitoring - offset - PDCCH - slot ) mod ( Monitoring - periodicity - PDCCH - slot ) = 0 ;$$

The starting symbol of a PDCCH monitoring occasion in each slot having PDCCH monitoring occasion is given by Monitoring-symbols-PDCCH-within-slot. The length (in symbols) of a PDCCH monitoring occasion is given in the corset associated with the search space. Search space configuration includes the identifier of coreset configuration associated with it. A list of coreset configurations are signaled by gNB for each configured BWP of serving cell wherein each coreset configuration is uniquely identified by an coreset identifier. Coreset identifier is unique amongst the BWPs of a serving cell.

Note that each radio frame is of 10 ms duration. Radio frame is identified by a radio frame number or system frame number. Each radio frame comprises of several slots wherein the number of slots in a radio frame and duration of slots depends on sub carrier spacing. The number of slots in a radio frame and duration of slots depends radio frame for each supported SCS is pre-defined in NR.

Each coreset configuration is associated with a list of Transmission configuration indicator (TCI) states. One DL reference signal (RS) ID (e.g., Synchronization Signal Block (SSB) or channel state information reference signal (CSI RS)) is configured per TCI state. The list of TCI states corresponding to a coreset configuration is signaled by gNB via RRC signaling. One of the TCI state in TCI state list is activated and indicated to UE by gNB. TCI state indicates the DL transmission (TX) beam (DL TX beam is quasi co located (QCLed) with SSB/CSI RS of TCI state) used by gNB for transmission of PDCCH in the PDCCH monitoring occasions of a search space.

### BWP Operation in 5G Wireless Communication System:

In 5G wireless communication system bandwidth adaptation (BA) is supported. With BA, the receive and transmit bandwidth of a UE need not be as large as the bandwidth of the cell and can be adjusted: the width can be ordered to change (e.g. to shrink during period of low activity to save power); the location can move in the frequency domain (e.g. to increase scheduling flexibility); and the subcarrier spacing can be ordered to change (e.g. to allow different services). A subset of the total cell bandwidth of a cell is referred to as a Bandwidth Part (BWP). BA is achieved by configuring RRC connected UE with BWP(s) and telling the UE which of the configured BWPs is currently the active one. When BA is configured, the UE only has to monitor PDCCH on the one active BWP i.e. it does not have to monitor PDCCH on the entire DL frequency of the serving cell. In RRC connected state, UE is configured with one or more DL and UL BWPs, for each configured Serving Cell (i.e. primary cell (PCell) or secondary cell (SCell)). For an activated Serving Cell, there is always one active UL and DL BWP at any point in time.

The BWP switching for a Serving Cell is used to activate an inactive BWP and deactivate an active BWP at a time. The BWP switching is controlled by the PDCCH indicating a downlink assignment or an uplink grant, by the bwp-Inactivity Timer, by RRC signaling, or by the medium access control (MAC) entity itself upon initiation of Random Access procedure.

Upon addition of special cell (SpCell) or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

### Carrier Aggregation (CA)/Multi-Connectivity in 5G Wireless Communication System:

The 5G wireless communication system supports standalone mode of operation as well dual connectivity (DC). In DC, a multiple reception (Rx)/Tx UE may be configured to utilise resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in RRC_CONNECTED is configured to utilise radio resources provided by two distinct schedulers, located in two different nodes connected via a non-ideal backhaul and providing either E-UTRA (i.e. if the node is an ng-eNB) or NR access (i.e. if the node is a gNB).

In NR, for a UE in RRC_CONNECTED not configured with CA/DC, there is only one serving cell comprising of the primary cell. For a UE in RRC_CONNECTED configured with CA/DC, the term ‘serving cells’ is used to denote the set of cells comprising of the Special Cell(s) and all secondary cells. In NR, the term Master Cell Group (MCG) refers to a group of serving cells associated with the Master Node, comprising of the PCell and optionally one or more SCells. In NR, the term Secondary Cell Group (SCG) refers to a group of serving cells associated with the Secondary Node, comprising of the PSCell and optionally one or more SCells. In NR, PCell (primary cell) refers to a serving cell in MCG, operating on the primary frequency, in which the UE either performs the initial connection establishment procedure or initiates the connection re-establishment procedure. In NR, for a UE configured with CA, Scell is a cell providing additional radio resources on top of Special Cell. Primary SCG Cell (PSCell) refers to a serving cell in SCG in which the UE performs random access when performing the Reconfiguration with Sync procedure. For Dual Connectivity operation, the term SpCell (i.e. Special Cell) refers to the PCell of the MCG or the PSCell of the SCG, otherwise the term Special Cell refers to the PCell.

In fifth generation wireless communication system, for multi-connectivity (also referred as MR-DC), Secondary Node (SN) Addition procedure is initiated by the MN and is used to establish a UE context at the SN in order to provide resources from the SN to the UE. For bearers requiring SCG radio resources, this procedure is used to add at least the initial SCG serving cell of the SCG.

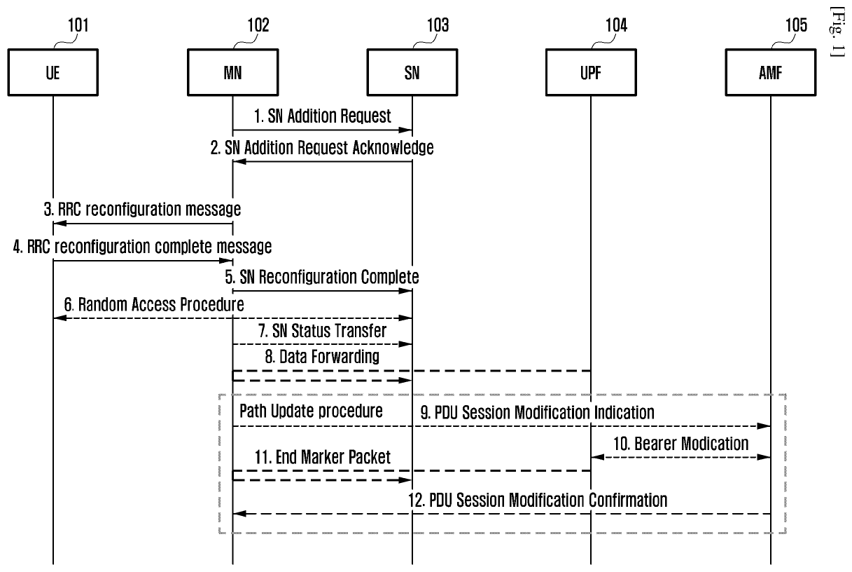

FIG. 1 illustrates an example of the SN addition procedure according to an embodiment of the disclosure.
1. The MN (102) decides to request the target SN (103) to allocate resources for one or more specific protocol data unit (PDU) Sessions/quality of service (QoS) Flows, indicating QoS Flows characteristics (QoS Flow Level QoS parameters, PDU session level transport network layer (TNL) address information, and PDU session level Network Slice info). In addition, for bearers requiring SCG radio resources, MN indicates the requested SCG configuration information, including the entire UE capabilities and the UE capability coordination result. In this case, the MN also provides the latest measurement results for SN to choose and configure the SCG cell(s). The MN may request the SCG to be activated or deactivated. The SN may reject the addition request.
2. If the radio resource management (RRM) entity in the SN is able to admit the resource request, the SN allocates respective radio resources and, dependent on the bearer type options, respective transport network resources. For bearers requiring SCG radio resources, the SN triggers UE Random Access so that synchronization of the SN radio resource configuration may be performed. The SN decides the PSCell and other SCG SCells and provides the new SCG radio resource configuration to the MN within an SN RRC configuration message contained in the SN Addition Request Acknowledge message.
3. The MN sends the MN RRC reconfiguration message to the UE (101) including the SN RRC configuration message, without modifying it. For example, within the MN RRC reconfiguration message, the MN may indicate the SCG is deactivated.
4. The UE applies the new configuration and replies to MN with MN RRC reconfiguration complete message, including an SN RRC response message for SN, if needed. In case the UE is unable to comply with (part of) the configuration included in the MN RRC reconfiguration message, the UE performs the reconfiguration failure procedure.
5. The MN informs the SN that the UE has completed the reconfiguration procedure successfully via SN Reconfiguration Complete message, including the SN RRC response message, if received from the UE.
6. If configured with bearers requiring SCG radio resources and the SCG is not deactivated, the UE performs synchronization towards the PSCell configured by the SN. The order the UE sends the MN RRC reconfiguration complete message and performs the Random Access procedure towards the SCG is not defined. The successful RA procedure towards the SCG is not required for a successful completion of the RRC Connection Reconfiguration procedure.
7. If Packet Data Convergence Protocol (PDCP) termination point is changed to the SN for bearers using radio link control (RLC) acknowledge mode (AM), and when RRC full configuration is not used, the MN sends the SN Status Transfer to the SN.
8. For SN terminated bearers or QoS flows moved from the MN, dependent on the characteristics of the respective bearer or QoS flow, the MN may take actions to minimize service interruption due to activation of MR-DC (Data forwarding).
9-12. If applicable, the update of the UP path towards the 5GC is performed via a PDU Session Path Update procedure. For example, MN transmits a PDU session modification indication message to Access and Mobility Management Function (AMF) (105), AMF performs bearer modification with user plane function (UPF) (104), and AMF transmits a PDU session modification confirm message to MN.

In multi-connectivity, power consumption of UE and network (e.g., MN, SN) is a big issue, due to maintaining two radio links simultaneously. In multi-connectivity deployment, MN provides the basic coverage. When UE data rate requirement changes dynamically, e.g. from high to low, SN may be released and added later again if needed. The release and addition to leads to significant signaling overhead and SN setup latency. So currently it is being studied to design an enhanced procedure for SN/SCG (de)activation to save energy consumption of UE and network.

To enable reasonable UE battery consumption, when multi-connectivity (e.g., MR-DC) is configured, an activation/deactivation mechanism of SCG is supported. While the SCG is deactivated, there is no transmission via SCG RLC bearers. While the SCG is deactivated, all SCell(s) of SCG are in deactivated state. The network may configure the SCG as activated or deactivated upon PSCell addition, PSCell change, RRC Resume or handover. The network may trigger SCG RRC reconfiguration (e.g. PSCell change) while the SCG is deactivated. NW-triggered SCG activation is indicated to the UE via the MCG. NW-triggered SCG deactivation may be indicated to the UE via the MCG. The MN may generate an RRC message with SCG (de)activation. The UE may indicate to the MN that the UE would like the SCG to be deactivated.

In the SCG deactivated state, the UE monitors some DL beams and, if the UE sees that the beams are not good enough, the UE either will perform random access upon reception of the next SCG activation indication from the MCG or report measurement results via the MCG and wait for reconfiguration. Both MN configured RRM measurements and SN configured RRM measurements are supported while the SCG is deactivated. When the SCG is deactivated, reports for measurements configured by the SN are sent on signaling radio bearer 1 (SRB1). When SCG is deactivated, the UE will not transmit PUSCH and SRS on SCG, and the UE is not required to monitor PDCCH on PSCell.

One of the issue is whether to perform Random access or not towards to PSCell upon activation of SN/SCG. It is proposed that upon receiving the activation command for the deactivated SCG, UE determines whether to perform RACH (i.e., random access procedure) towards PSCell as follows:
If time alignment timer (TAT) is not running; or
if reference signal received power (RSRP) has changed more than a threshold since SCG was deactivated; or
if activated PSCell is not the one which was last deactivated (i.e. PSCell has changed during the deactivation); or
If activation command explicitly indicates UE to perform RA:
   UE initiates RA on activated PSCell.
Else
   UE does not initiate RA upon activating PSCell.

This operation does not take into account beam based communication in PSCell. Additional criteria need to be considered in a deployment in which PSCell is deployed on higher frequencies which requires beamforming.

Hereinafter, operations of the UE, MN and/or SN according to SCG activation/deactivation will be described in consideration of the PSCell deployed on higher frequency bands requiring beamforming.

### Embodiment 1: RACH Trigger Upon SCG Activation

### <Method 1-1>

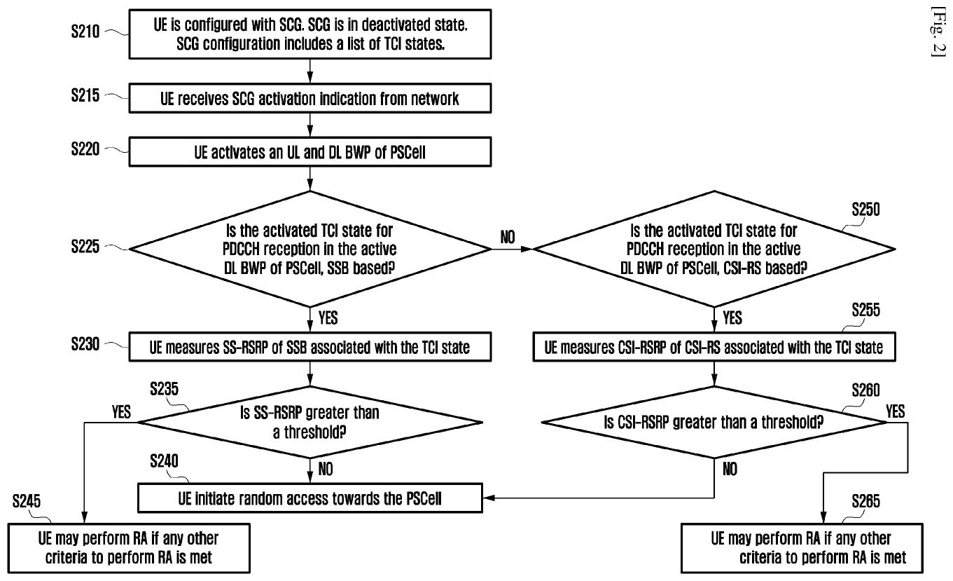

FIG. 2 illustrates an example of a UE operation related to RACH trigger upon SCG activation according to an embodiment of the disclosure.

In step S210, UE is configured with SCG. The SCG includes at least PSCell. A PSCell configuration is provided to the UE. The PSCell configuration includes a list of TCI states. The list of TCI states is configured separately for each configured DL BWP. The SCG may be previously activated and the SCG is currently deactivated upon an indication by network. The current state of SCG is in deactivated state. For example, the indication to deactivate SCG is sent via an RRCReconfiguration message, MAC CE, DCI in PDCCH, or any other signaling mechanism.

While the SCG is deactivated, UE may receive information including an indication to activate the SCG from the network (S215). The information including the indication to activate SCG is received from MCG. For example, the information including the indication to activate SCG is received via RRCReconfiguration message, MAC CE or DCI in PDCCH.

Upon receiving, from the network, the indication to activate the SCG, UE may activate an UL BWP and a DL BWP of PSCell from the list of UL BWPs and DL BWPs in PSCell configuration (S220).

In an embodiment, UE may activate the UL BWP with a BWP ID given by firstActiveUplinkBWP-Id, and UE may activate the DL BWP with a BWP ID given by firstActiveDownlinkBWP-Id. The parameters firstActiveUplinkBWP-Id and firstActiveDownlinkBWP-Id are signaled by gNB in PSCell configuration via RRCReconfiguration message.

In an alternate embodiment, UE may activate the UL BWP which was last activated for PSCell (i.e. UL BWP which was active at the time of deactivation of SCG), and UE may activate the DL BWP which was last activated for PSCell (i.e. DL BWP which was active at the time of deactivation of SCG).

In an alternate embodiment, the UL and DL BWP to be activated upon SCG activation may be signaled by gNB in PSCell configuration via RRCReconfiguration message or in signaling message used to activate SCG. UE may activate these UL and DL BWP.

In an embodiment, UE may activate the DL BWP, whose TCI state for PDCCH reception is activated; UE may activate the UL BWP with same BWP ID as the activated DL BWP.

UE then may check the reference signal (e.g., CSI-RS or SSB) associated with the activated TCI state for PDCCH reception in the active DL BWP of PSCell (S225, S250). It is assumed that one of the TCI states in the list of TCI states for the active DL BWP of PSCell is activated by gNB. In an embodiment, the activated TCI state of PSCell may be signaled by gNB (via SCG) while the SCG was active before the deactivation. In an alternate embodiment, the activated TCI state of PSCell may be signaled by gNB (via MCG) in the signaling message used to activate the SCG. In an alternate embodiment, the activated TCI state of PSCell may be signaled by gNB (via MCG) while the SCG is deactivated.

If the reference signal associated with the activated TCI state for PDCCH reception in the active DL BWP of PSCell is SSB, UE may measure the SS-RSRP of that SSB (S230). UE may compare the SS-RSRP with a threshold (S235). If SS-RSRP is less than a configured threshold (i.e. not greater than or equal to a threshold), UE may initiate random access procedure towards the PSCell (S240). Alternately, if SS-RSRP is less than or equal to a configured threshold (i.e. not greater than a threshold), UE may initiate random access procedure towards the PSCell (S240). The threshold is signaled by gNB (e.g. in RRCReconfiguration message). The threshold may be cell specific or BWP specific. The threshold may be separately configured for SS-RSRP and CSI-RSRP.

If the reference signal associated with the activated TCI state for PDCCH reception in the active DL BWP of PSCell is CSI-RS (S250), UE measures the CSI-RSRP of that CSI-RS (S255). UE may compare the CSI-RSRP with a threshold (S260). If CSI-RSRP is less than a configured threshold (i.e. not greater than or equal to a threshold), UE may initiate random access procedure towards the PSCell (S240). Alternately, if CSI-RSRP is less than or equal to a configured threshold (i.e. not greater than a threshold), UE may initiate random access procedure towards the PSCell(S240). The threshold may be signaled by gNB (e.g. in RRCReconfiguration message). The threshold may be cell specific or BWP specific. The threshold may be separately configured for SS-RSRP and CSI-RSRP.

If RSRP criteria in step S235 or step S260 is not met, UE may initiate random access procedure towards the PSCell if any other criteria to perform random access procedure is met (S245, S265), such as
If TAT is not running; or
if RSRP has changed more than a threshold since SCG was deactivated; or
if activated PSCell is not the one which was last deactivated (i.e. PSCell has changed during the deactivation); or
If activation command explicitly indicates UE to perform RA:
   UE initiates RA on activated PSCell.
Else
   UE does not initiate RA upon activating PSCell.

### <Method 1-2>

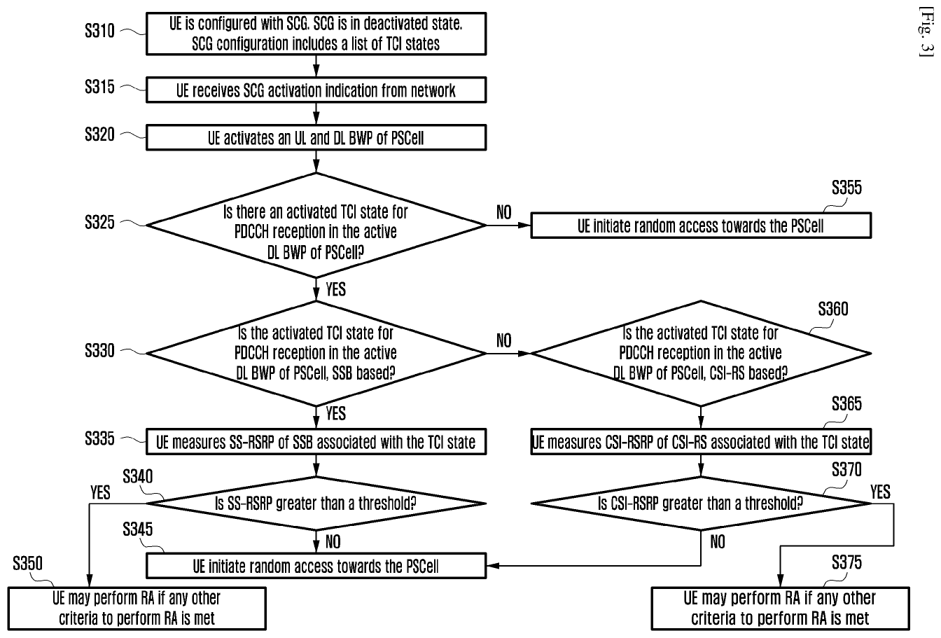

FIG. 3 illustrates another example of the UE operation related to RACH trigger upon SCG activation according to an embodiment of the disclosure. In step S310, UE is configured with SCG. The SCG includes at least PSCell. A PSCell configuration is provided to the UE. The PSCell configuration includes a list of TCI states where the list of TCI states is configured separately for each configured DL BWP. The SCG may be previously activated and the SCG is currently deactivated upon network indication by network (e.g., MN). The current state of SCG is in deactivated state. For example, the indication to deactivate the SCG is sent via an RRCReconfiguration message, MAC CE, DCI in PDCCH, or any other signaling mechanism.

While the SCG is deactivated, UE may receive information including an indication to activate the SCG from network (S315). The information including an indication to activate SCG is received from MCG. For example, the information including the indication to activate SCG is received via RRCReconfiguration message, MAC CE or DCI in PDCCH.

Upon receiving, from network, the indication to activate the SCG, UE may activate an UL BWP and a DL BWP from the list of UL BWPs and DL BWPs in PSCell configuration (S320).

In an embodiment, UE may activate the UL BWP with a BWP ID given by firstActiveUplinkBWP-Id, and UE may activate the DL BWP with BWP ID given by firstActiveDownlinkBWP-Id. The parameters firstActiveUplinkBWP-Id and firstActiveDownlinkBWP-Id are signaled by gNB in PSCell configuration via RRCReconfiguration message.

In an alternate embodiment, UE may activate the UL BWP which was last activated for PSCell (i.e. UL BWP which was active at the time of deactivation of SCG), and UE may activate the DL BWP which was last activated for PSCell (i.e. DL BWP which was active at the time of deactivation of SCG).

In an alternate embodiment, the UL and DL BWP to be activated upon SCG activation may be signaled by gNB in PSCell configuration via RRCReconfiguration message or in signaling message used to activate SCG. UE may activate these UL and DL BWP.

In an embodiment, UE may activate the DL BWP, whose TCI state for PDCCH reception is activated, and UE may activate the UL BWP with same BWP ID as the activated DL BWP.

UE then may check if there is any activated TCI state for PDCCH reception amongst the TCI states in list of TCI states of the active DL BWP of PSCell (S325). If there isn't any activated TCI state for PDCCH reception amongst the TCI states in list of TCI states of the active DL BWP of PSCell, UE may initiate random access procedure towards the PSCell (S355). Otherwise, UE go to step S330.

UE then may check the reference signal (e.g., CSI-RS or SSB) associated with the activated TCI state for PDCCH reception in the active DL BWP of PSCell (S330). It is assumed that one of the TCI states in the list of TCI states for the active DL BWP of PSCell is activated by gNB. In an embodiment, the activated TCI state of PSCell may be signaled by gNB (via SCG) while the SCG was active before the deactivation. In an alternate embodiment, the activated TCI state of PSCell may be signaled by gNB (via MCG) in the signaling message used to activate the SCG. In an alternate embodiment, the activated TCI state of PSCell may be signaled by gNB (via MCG) while the SCG is deactivated.

If the reference signal associated with the activated TCI state for PDCCH reception in the active DL BWP of PSCell is SSB, UE may measure the SS-RSRP of that SSB (S335). UE may compare the SS-RSRP with a threshold (S340). If SS-RSRP is less than a configured threshold (i.e. not greater than or equal to a threshold), UE may initiate random access procedure towards the PSCell (S345). Alternately, if SS-RSRP is less than or equal to a configured threshold (i.e. not greater than a threshold), UE may initiate random access procedure towards the PSCell (S345). The threshold may be signaled by gNB (e.g. in RRCReconfiguration message). The threshold may be cell specific or BWP specific. The threshold may be separately configured for SS-RSRP and CSI-RSRP.

If the reference signal associated with the activated TCI state for PDCCH reception in the active DL BWP of PSCell is CSI-RS (S360), UE may measure the CSI-RSRP of that CSI-RS (S365). UE may compare the CSI-RSRP with a threshold (S370). If CSI-RSRP is less than a configured threshold (i.e. not greater than or equal to a threshold), UE may initiate random access procedure towards the PSCell (S345). Alternately, if CSI-RSRP is less than or equal to a configured threshold (i.e. not greater than a threshold), UE may initiate random access procedure towards the PSCell (S345). The threshold may be signaled by gNB (e.g. in RRCReconfiguration message). The threshold may be cell specific or BWP specific. The threshold may be separately configured for SS-RSRP and CSI-RSRP.

If RSRP criteria in step S340 or step S370 is not met, UE may initiate random access procedure towards the PSCell if any other criteria to perform random access procedure is met (S350, S375), such as
If TAT is not running; or
if RSRP has changed more than a threshold since SCG was deactivated; or
if activated PSCell is not the one which was last deactivated (i.e. PSCell has changed during the deactivation); or
If activation command explicitly indicates UE to perform RA:
   UE initiates RA on activated PSCell.
Else
   UE does not initiate RA upon activating PSCell.

### <Method 1-3>

In one embodiment of the disclosure, the UE operation related to RACH trigger upon SCG activation according to an embodiment of the disclosure is as follows.
1. UE is configured with SCG. The SCG includes at least PSCell. A PSCell configuration is provided to the UE. The PSCell configuration includes a list of TCI states where the list of TCI states is configured separately for each configured DL BWP. The SCG may be previously activated and the SCG is currently deactivated upon indication by network (e.g., MN). The current state of SCG is deactivated state. For example, the indication to deactivate the SCG is sent via an RRCReconfiguration message, MAC CE, DCI in PDCCH, or any other signaling mechanism.
2. While the SCG is deactivated, UE may receive information including an indication to activate the SCG from network. The information including the indication to activate SCG is received from MCG. For example, the information including the indication to activate SCG is received via RRCReconfiguration message, MAC CE or DCI in PDCCH.
3. Upon receiving, from network, the indication to activate the SCG, UE may activate an UL BWP and DL BWP from the list of UL BWPs and DL BWPs in PSCell configuration.

In an embodiment, UE may activate the UL BWP with a BWP ID given by firstActiveUplinkBWP-Id, and UE may activate the DL BWP with a BWP ID given by firstActiveDownlinkBWP-Id. The parameters firstActiveUplinkBWP-Id and firstActiveDownlinkBWP-Id are signaled by gNB in PSCell configuration via RRCReconfiguration message.

In an alternate embodiment, UE may activate the UL BWP which was last activated for PSCell (i.e. UL BWP which was active at the time of deactivation of SCG), and UE may activate the DL BWP which was last activated for PSCell (i.e. DL BWP which was active at the time of deactivation of SCG).

In an alternate embodiment, the UL and DL BWP to be activated upon SCG activation may be signaled by gNB in PSCell configuration via RRCReconfiguration message or in signaling message used to activate SCG. UE may activate these UL and DL BWP.
4. Then, UE may check whether PSCell has changed since SCG deactivation. If PSCell has changed, UE may initiate random access procedure towards the PSCell. Otherwise, UE goes to step 5.
5. UE may check if there is any activated TCI state for PDCCH reception amongst the TCI states in list of TCI states of the active DL BWP of PSCell. If there isn't any activated TCI state for PDCCH reception amongst the TCI states in list of TCI states of the active DL BWP of PSCell, UE may initiate random access procedure towards the PSCell. Otherwise, UE goes to step 6.
6. UE may check the reference signal (e.g., CSI-RS or SSB) associated with the activated TCI state for PDCCH reception in the active DL BWP of PSCell. It is assumed that one of the TCI states in the list of TCI states for the active DL BWP of PSCell is activated by gNB. In an embodiment, the activated TCI state of PSCell may be signaled by gNB (via SCG) while the SCG was active before the deactivation. In an alternate embodiment, the activated TCI state of PSCell may be signaled by gNB (via MCG) in the signaling message used to activate the SCG. In an alternate embodiment, the activated TCI state of PSCell may be signaled by gNB (via MCG) while the SCG is deactivated.
7. If the reference signal associated with the activated TCI state for PDCCH reception in the active DL BWP of PSCell is SSB, UE may measure the SS-RSRP of that SSB. If SS-RSRP is less than a configured threshold (i.e. not greater than or equal to a threshold), UE may initiate random access procedure towards the PSCell. Alternately, if SS-RSRP is less than or equal to a configured threshold (i.e. not greater than a threshold), UE may initiate random access procedure towards the PSCell. The threshold may be signaled by gNB (e.g. in RRCReconfiguration message). The threshold may be cell specific or BWP specific. The threshold may be separately configured for SS-RSRP and CSI-RSRP.
8. If the reference signal associated with the activated TCI state for PDCCH reception in the active DL BWP of PSCell is CSI-RS, UE may measure the CSI-RSRP of that CSI-RS. If CSI-RSRP is less than a configured threshold (i.e. not greater than or equal to a threshold), UE may initiate random access procedure towards the PSCell. Alternately, if CSI-RSRP is less than or equal to a configured threshold (i.e. not greater than a threshold), UE may initiate random access procedure towards the PSCell. The threshold may be signaled by gNB (e.g. in RRCReconfiguration message). The threshold may be cell specific or BWP specific. The threshold may be separately configured for SS-RSRP and CSI-RSRP.
9. if RSRP criteria in step 7) or step 8) is not met, UE may initiate random access procedure towards the PSCell if any other criteria to perform random access procedure is met, such as
   If TAT is not running; or
   if RSRP has changed more than a threshold since SCG was deactivated; or
   If activation command explicitly indicates UE to perform RA:
      UE initiates RA on activated PSCell.
   Else
      UE does not initiate RA upon activating PSCell.

### <Method 1-4>

1. UE is configured with MCG and SCG. SCG is in activated state. PSCell is serving cell A. UE is configured with multiple TCI states for SCG (i.e. PSCell). TCI state X is activated by gNB for PDCCH monitoring while the SCG is activated. X is an identifier of the TCI state.
2. UE receives a command to deactivate SCG. SCG is deactivated based on the command. While the SCG is deactivated, SCG configuration may be reconfigured.
3. While the SCG is deactivated, UE may receive information including an indication to activate the SCG from the network (e.g., MN). The information including indication to activate SCG is received from MCG. For example, the information including the indication to activate SCG is received via RRCReconfiguration message, MAC CE or DCI in PDCCH.
4. Upon receiving, from the network, the indication to activate the SCG, UE may activate an UL BWP and a DL BWP from the list of UL BWPs and DL BWPs in PSCell configuration.

In an embodiment, UE may activate the UL BWP with a BWP ID given by firstActiveUplinkBWP-Id, and UE may activate the DL BWP with a BWP ID given by firstActiveDownlinkBWP-Id. The parameters firstActiveUplinkBWP-Id and firstActiveDownlinkBWP-Id are signaled by gNB in PSCell configuration via RRCReconfiguration message.

In an alternate embodiment, UE may activate the UL BWP which was last activated for PSCell (i.e. UL BWP which was active at the time of deactivation of SCG), and UE may activate the DL BWP which was last activated for PSCell (i.e. DL BWP which was active at the time of deactivation of SCG).

In an alternate embodiment, the UL and DL BWP to be activated upon SCG activation may be signaled by gNB in PSCell configuration via RRCReconfiguration message or in signaling message used to activate SCG. UE may activate these UL and DL BWP.
5. If PSCell in latest SCG configuration is serving cell A (i.e. PSCell has not changed since SCG deactivation) and if TCI state X is included in list of TCI states for active DL BWP in latest SCG configuration of serving cell A:

If TCI-state X is SSB based, UE may measure SS-RSRP of SSB corresponding to TCI state X. If SS-RSRP is not greater than a configured threshold, UE may initiate random access procedure towards the PSCell. The threshold may be signaled by gNB (e.g. in RRCReconfiguration message). The threshold may be cell specific or BWP specific.

If TCI-state X is CSI-RS based, UE may measure CSI-RSRP of CSI-RS corresponding to TCI state X. If CSI-RSRP is not greater than a configured threshold, UE may initiate random access procedure towards the PSCell. The threshold may be signaled by gNB (e.g. in RRCReconfiguration message). The threshold may be cell specific or BWP specific.
6. If PSCell in latest SCG configuration is serving cell A (i.e. PSCell has not changed since SCG deactivation) and TCI state X is not included in list of TCI states for active DL BWP in latest SCG configuration of serving cell A: UE may initiate random access procedure towards the PSCell.

### <Method 1-5>

1. UE is configured with MCG and SCG. SCG is in activated state. PSCell is serving cell A. UE is configured with multiple TCI states for SCG (i.e. PSCell). TCI state X is activated by gNB for PDCCH monitoring while the SCG is activated
2. UE receives a command to deactivate SCG. SCG is deactivated based on the command. While the SCG is deactivated, SCG configuration may be reconfigured
3. While the SCG is deactivated, UE may receive information including an indication to activate the SCG from network. The information including the indication to activate SCG is received from MCG. For example, the information including the indication to activate SCG is received via RRCReconfiguration message, MAC CE or DCI in PDCCH.
4. Upon receiving, from network, the indication to activate the SCG, UE may activate an UL BWP and a DL BWP from the list of UL BWPs and DL BWPs in PSCell configuration.

In an embodiment, UE may activate the UL BWP with a BWP ID given by firstActiveUplinkBWP-Id, and UE may activate the DL BWP with BWP ID given by firstActiveDownlinkBWP-Id, where parameters firstActiveUplinkBWP-Id and firstActiveDownlinkBWP-Id are signaled by gNB in PSCell configuration via RRCReconfiguration message.

In an alternate embodiment, UE may activate the UL BWP which was last activated for PSCell (i.e. UL BWP which was active at the time of deactivation of SCG), and UE may activate the DL BWP which was last activated for PSCell (i.e. DL BWP which was active at the time of deactivation of SCG).

In an alternate embodiment, the UL and DL BWP to be activated upon SCG activation may be signaled by gNB in PSCell configuration via RRCReconfiguration message or in signaling message used to activate SCG. UE may activate these UL and DL BWP.
5. If PSCell has not changed since SCG deactivation and if last activated TCI state of PSCell is included in list of TCI states for active DL BWP in latest SCG configuration of serving cell A:

If TCI-state X is SSB based, UE may measure SS-RSRP of SSB corresponding to TCI state X. If SS-RSRP is not greater than a configured threshold, UE may initiate random access procedure towards the PSCell. The threshold may be signaled by gNB (e.g. in RRCReconfiguration message). The threshold may be cell specific or BWP specific.

If TCI-state X is CSI-RS based, UE may measure CSI-RSRP of CSI-RS corresponding to TCI state X. If CSI-RSRP is not greater than a configured threshold, UE may initiate random access procedure towards the PSCell. The threshold may be signaled by gNB (e.g. in RRCReconfiguration message). The threshold may be cell specific or BWP specific.
6. If PSCell has not changed since SCG deactivation and if last activated TCI state of PSCell is not included in list of TCI states for active DL BWP in latest SCG configuration of serving cell A: UE may initiate random access procedure towards the PSCell.

In the above-described embodiments of Methods 1-1 to 1-5, the examples of the TCI state for the PDCCH have been mainly described, but the scope of the present disclosure is not limited thereto, and it is also applicable to the TCI state for the dedicated downlink channel (e.g. PDSCH, PDCCH) reception.

### Embodiment 2: TCI State Activation/Update for Deactivated SCG

Hereinafter, a method of activating/updating the TCI state for the deactivated SCG will be described.

### <Method 2-1>

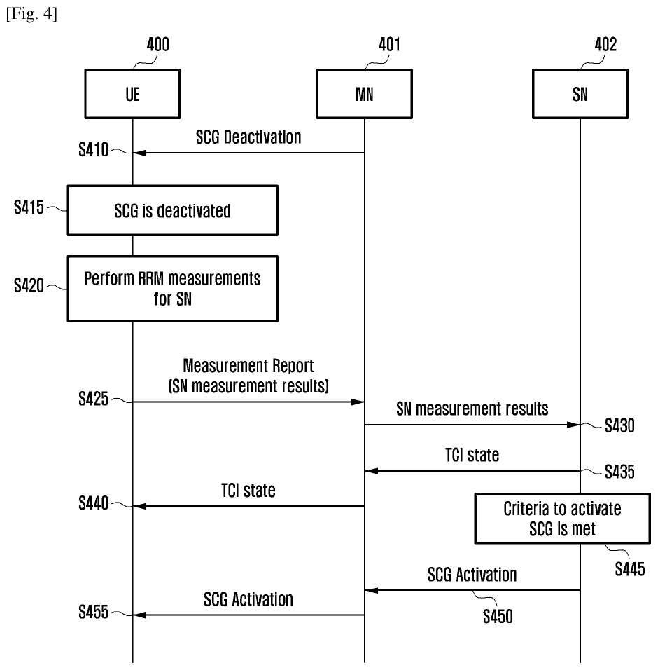

FIG. 4 illustrates an example of a signaling flow for activating/updating a TCI state for deactivated SCG according to an embodiment of the disclosure.

Referring to FIG. 4, it is assumed that dual connectivity consisting of MN (401) and SN (402) is configured for the UE (400).

UE (400) is configured with SCG of SN (402). The SCG includes at least PSCell. A PSCell configuration is provided to the UE. The PSCell configuration includes a list of TCI states where the list of TCI states is configured separately for each configured DL BWP. The SCG may be previously activated and the SCG is currently deactivated upon an indication by network (e.g, MN) (S410). MN may transmit, to the UE, information including the indication to deactivate the SCG. The current state of SCG is in deactivated state. For example, the indication to deactivate the SCG is sent via an RRCReconfiguration message, MAC CE, DCI in PDCCH, or any other signaling mechanism.

While the SCG is deactivated (S415), UE may perform RRM measurements for SCG (i.e., PSCell) (S420). The RRM measurements may be configured by MN or SN.

UE may send the measurement report for deactivated SCG (i.e., PSCell) to MN (S425). The measurement report may include a metric indicating cell quality of PSCell. The measurement report also may include SSB/CSI-RS measurements for one or more RSs (e.g., SSB/CSI-RS).

Upon receiving the measurement report, MN may forward the measurement report to SN (S430). SN may decide the TCI state to be activated for PSCell based on the measurement report. The TCI state to be activated may be sent to MN (S435). In other words, SN may transmit information on the TCI state to be activated to MN. MN may send the TCI state to be activated for PSCell to UE (S440). This TCI state may be used by UE upon activation of SCG. The TCI state may be one of the TCI state in the list of TCI states of DL BWP which will be activated upon SCG activation.
In an embodiment, the DL BWP to be activated is the BWP with a BWP ID given by firstActiveDownlinkBWP-Id.
In an alternate embodiment, the DL BWP to be activated is the BWP which was last activated for PSCell (i.e. DL BWP which was active at the time of deactivation of SCG).

(Alternate) Upon receiving the measurement report, MN may decide the TCI state to be activated for PSCell. MN may send the TCI state to be activated for PSCell to UE (S440). This TCI state may be used by UE upon activation of SCG. The TCI state may be one of the TCI state in the list of TCI states of DL BWP which will be activated upon SCG activation.
In an embodiment, the DL BWP to be activated is the BWP with BWP ID given by firstActiveDownlinkBWP-Id.
In an alternate embodiment, the DL BWP to be activated is the BWP which was last activated for PSCell (i.e. DL BWP which was active at the time of deactivation of SCG).

CORESET ID may also be signaled along with TCI state. If the CORESET ID is set to 0, TCI state is one of the first 64 TCI-states configured by tci-States-ToAddModList and tci-States-ToReleaseList in the PDSCH-Config in the BWP which will be activated upon SCG activation. If the CORESET ID is set to the other value than 0, TCI state is one of the TCI state configured by tci-StatesPDCCH-ToAddList and tciStatesPDCCH-ToReleaseList in the controlResourceSet identified by the indicated CORESET ID. CORESET ID is unique across the coresets of all BWPs, so CORESET ID may implicitly indicate the BWP of indicated TCI state.

SN may identify whether criteria to activate SCG (SCG activation may be requested by the MN, by the UE or by the SN which can decide itself. For example, the SN may activate SCG when DL data arrival for SCG bearer(s). For another example, for UL data arrival on SCG bearer(s) while the SCG is deactivated, the UE may indicate to the MN that it has UL data to transmit over SCG bearer) is met (S445) and transmit information for indicating SCG activation (S450) to MN.

While the SCG is deactivated, UE may receive information including an indication to activate the SCG from network (e.g., MN) (S455). The information including the indication to activate SCG is received from MCG. For example, the information including the indication is received via RRCReconfiguration message, MAC CE, or DCI in PDCCH.

Upon receiving, from network, the indication to activate the SCG, UE may activate an UL BWP and a DL BWP from the list of UL BWPs and DL BWPs in PSCell configuration.

In an embodiment, UE may activate the UL BWP with a BWP ID given by firstActiveUplinkBWP-Id, and UE may activate the DL BWP with a BWP ID given by firstActiveDownlinkBWP-Id, where parameters firstActiveUplinkBWP-Id and firstActiveDownlinkBWP-Id are signaled by gNB in PSCell configuration via RRCReconfiguration message.

In an alternate embodiment, UE may activate the UL BWP which was last activated for PSCell (i.e. UL BWP which was active at the time of deactivation of SCG), and UE may activate the DL BWP which was last activated for PSCell (i.e. DL BWP which was active at the time of deactivation of SCG).

In an alternate embodiment, the UL and DL BWP to be activated upon SCG activation may be signaled by gNB in PSCell configuration via RRCReconfiguration message or in signaling message used to activate SCG. UE may activate these UL and DL BWP.

UE may use the activated TCI state for PDCCH reception on PSCell (i.e. UE assumes the PDCCH transmission from PSCell is QCled (e.g. in spatial domain) with RS transmission associated with the TCI state). Alternately, UE then may check the reference signal (e.g., CSI-RS or SSB) associated with the activated TCI state for PDCCH reception in the active DL BWP of PSCell.

If the reference signal associated with the activated TCI state for PDCCH reception in the active DL BWP of PSCell is SSB, UE may measure the SS-RSRP of that SSB. If SS-RSRP is greater than a configured threshold, UE may use this TCI state for PDCCH reception on PSCell (i.e. UE assumes the PDCCH transmission from PSCell is QCled (e.g. in spatial domain) with RS transmission associated with the TCI state). The threshold may be signaled by gNB (e.g. in RRCReconfiguration message). The threshold may be cell specific or BWP specific. The threshold may be separately configured for SS-RSRP and CSI-RSRP.

If the reference signal associated with the activated TCI state for PDCCH reception in the active DL BWP of PSCell is CSI-RS, UE may measure the CSI-RSRP of that CSI-RS. If CSI-RSRP is greater than a configured threshold, UE may use this TCI state for PDCCH reception on PSCell (i.e. UE assumes the PDCCH transmission from PSCell is QCled (e.g. in spatial domain) with RS transmission associated with the TCI state). The threshold may be signaled by gNB (e.g. in RRCReconfiguration message). The threshold may be cell specific or BWP specific. The threshold may be separately configured for SS-RSRP and CSI-RSRP.

### <Method 2-2>

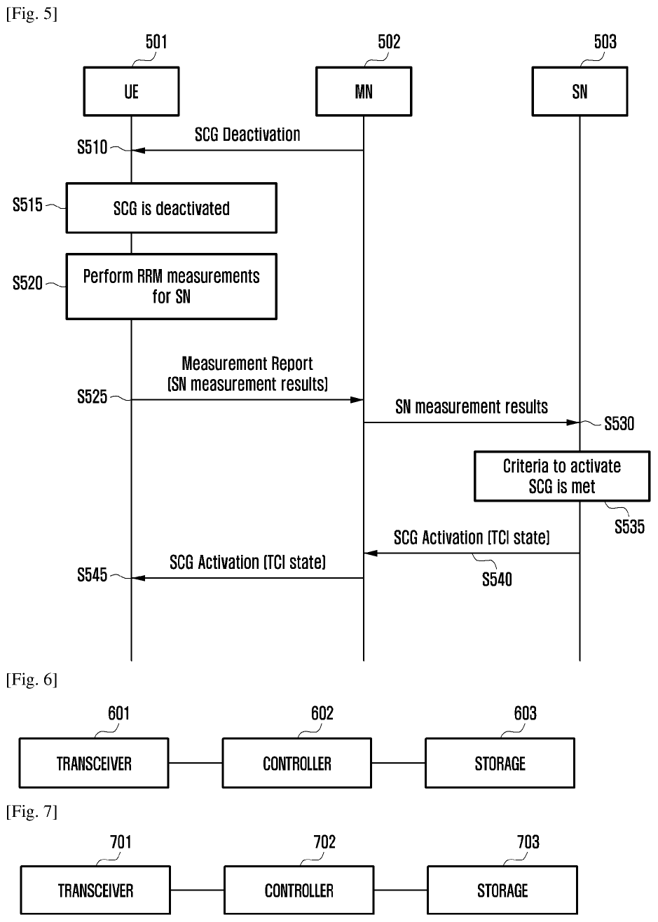

FIG. 5 illustrates another example of a signaling flow for activating/updating a TCI state for deactivated SCG according to an embodiment of the disclosure.

Referring to FIG. 5, it is assumed that dual connectivity consisting of MN (502) and SN (503) is configured for the UE (501).

UE (501) is configured with SCG of SN (503). The SCG includes at least PSCell. A PSCell configuration is provided to the UE. The PSCell configuration includes a list of TCI states where the list of TCI states is configured separately for each configured DL BWP. The SCG may be previously activated and the SCG is currently deactivated upon an indication by network (e.g., MN). The MN may transmit information including the indication to deactivate the SCG (S510). The current state of SCG is in deactivated state. For example, the indication to deactivate the SCG is sent via an RRCReconfiguration message, MAC CE, DCI in PDCCH, or any other signaling mechanism.

While the SCG is deactivated (S515), UE may perform RRM measurements for SCG (i.e. PSCell) (S520). The RRM measurements may be configured by MN or SN.

UE may send the measurement report for deactivated SCG (i.e. PSCell) to MN (S525). The measurement report may include metric indicating cell quality of PSCell. The measurement report also may include SSB/CSI-RS measurements for one or more RSs (e.g., SSB/CSI-RS).

Upon receiving the measurement report, MN may forward the measurement report to SN (S530). SN may store the measurement report. SN may decide the TCI state to be activated for PSCell based on the measurement report when criterial to activate SCG is met (S535). The TCI state to be activated is sent to MN along with SCG activation command (S540). Then, MN may send the TCI state to be activated for PSCell to UE along with the SCG activation command (S545). This TCI state may be used by UE upon activation of SCG. The TCI state may be one of the TCI state in the list of TCI states of DL BWP which will be activated upon SCG activation.
In an embodiment, the DL BWP to be activated is the BWP with a BWP ID given by firstActiveDownlinkBWP-Id.
In an alternate embodiment, the DL BWP to be activated is the BWP which was last activated for PSCell (i.e. DL BWP which was active at the time of deactivation of SCG).

(Alternate) Upon receiving the measurement report, MN may store the measurement report. MN may decide the TCI state to be activated for PSCell based on the measurement report when criterial to activate SCG is met e.g., when MN receives activation command from SN. Then, MN may send the TCI state to be activated for PSCell to UE along with activation command. This TCI state may be used by UE upon activation of SCG. The TCI state may be one of the TCI state in the list of TCI states of DL BWP which will be activated upon SCG activation.
In an embodiment, the DL BWP to be activated is the BWP with a BWP ID given by firstActiveDownlinkBWP-Id.
In an alternate embodiment, the DL BWP to be activated is the BWP which was last activated for PSCell (i.e. DL BWP which was active at the time of deactivation of SCG).

CORESET ID may also be signaled along with TCI state. If the CORESET ID is set to 0, TCI state is one of the first 64 TCI-states configured by tci-States-ToAddModList and tci-States-ToReleaseList in the PDSCH-Config in the BWP which will be activated upon SCG activation. If the CORESET ID is set to the other value than 0, TCI state is one of the TCI state configured by tci-StatesPDCCH-ToAddList and tciStatesPDCCH-ToReleaseList in the controlResourceSet identified by the indicated CORESET ID. CORESET ID is unique across the coresets of all BWPs, so CORESET ID may implicitly indicate the BWP of indicated TCI state.

SN may identify whether criteria to activate SCG (SCG activation may be requested by the MN, by the UE or by the SN which can decide itself. For example, the SN may activate SCG when DL data arrival for SCG bearer(s). For another example, for UL data arrival on SCG bearer(s) while the SCG is deactivated, the UE may indicate to the MN that it has UL data to transmit over SCG bearer) is met and transmit information for indicating SCG activation to MN.

While the SCG is deactivated, UE may receive information including an indication to activate the SCG from network (e.g., MN). The information including the indication to activate SCG is received from MCG. For example, the information including the indication is received via RRCReconfiguration message, MAC CE, or DCI in PDCCH.

Upon receiving, from network, the indication to activate the SCG, UE may activate an UL BWP and a DL BWP from the list of UL BWPs and DL BWPs in PSCell configuration.

In an embodiment, UE may activate the UL BWP with BWP ID given by firstActiveUplinkBWP-Id, and UE may activate the DL BWP with BWP ID given by firstActiveDownlinkBWP-Id. The parameters firstActiveUplinkBWP-Id and firstActiveDownlinkBWP-Id are signaled by gNB in PSCell configuration via RRCReconfiguration message.

In an alternate embodiment, UE may activate the UL BWP which was last activated for PSCell (i.e. UL BWP which was active at the time of deactivation of SCG), UE may activate the DL BWP which was last activated for PSCell (i.e. DL BWP which was active at the time of deactivation of SCG).

In an alternate embodiment, the UL and DL BWP to be activated upon SCG activation may be signaled by gNB in PSCell configuration via RRCReconfiguration message or in signaling message used to activate SCG. UE may activate these UL and DL BWP.

UE may use the activated TCI state for PDCCH reception on PSCell (i.e. UE assumes the PDCCH transmission from PSCell is QCled (e.g. in spatial domain) with RS transmission associated with the TCI state). Alternately, UE then may check the reference signal (e.g., CSI-RS or SSB) associated with the activated TCI state for PDCCH reception in the active DL BWP of PSCell.

If the reference signal associated with the activated TCI state for PDCCH reception in the active DL BWP of PSCell is SSB, UE may measure the SS-RSRP of that SSB. If SS-RSRP is greater than a configured threshold, UE may use this TCI state for PDCCH reception on PSCell (i.e. UE assumes the PDCCH transmission from PSCell is QCled (e.g. in spatial domain) with RS transmission associated with the TCI state). The threshold may be signaled by gNB (e.g. in RRCReconfiguration message). The threshold may be cell specific or BWP specific. The threshold may be separately configured for SS-RSRP and CSI-RSRP.

If the reference signal associated with the activated TCI state for PDCCH reception in the active DL BWP of PSCell is CSI-RS, UE may measure the CSI-RSRP of that CSI-RS. If CSI-RSRP is greater than a configured threshold, UE may use this TCI state for PDCCH reception on PSCell (i.e. UE assumes the PDCCH transmission from PSCell is QCled (e.g. in spatial domain) with RS transmission associated with the TCI state). The threshold may be signaled by gNB (e.g. in RRCReconfiguration message). The threshold may be cell specific or BWP specific. The threshold may be separately configured for SS-RSRP and CSI-RSRP.

In the above-described embodiments of Methods 2-1 to 2-2, the examples of the TCI state for the PDCCH have been mainly described, but the scope of the present disclosure is not limited thereto, and it is also applicable to the TCI state for the PDSCH reception.

The embodiments (e.g., embodiment 1/2) and/or methods (e.g., methods 1-1/1-2/1-3/1-4/1-5/2-1/2-2) provided in the disclosure may be performed by a UE and/or a base station of FIGS. 6 and 7.

In an embodiment, the UE may identify that a SCG is deactivated. For example, the UE may receive information including an indication to deactivate the SCG and identify deactivation of the SCG based on the information. While the SCG is deactivated, the UE may perform RRM measurements for the PSCell and transmit a report of the RRM measurements to the MN. The UE may receive information on a TCI state for a PSCell. For example, the information on the TCI state for the PSCell is received while the SCG is deactivated. For another example, the information on the TCI state for the PSCell is received with information for activating the SCG. The UE may receive information for activating the SCG. For example, the information for activating the SCG includes information on a downlink BWP to be activated for the PSCell upon activation of the SCG. The TCI state may be activated for a PDCCH or a PDSCH on the PSCell of the SCG activated based on the information for activating the SCG. The UE may measure a RSRP based on a reference signal on the PSCell, upon activation of the SCG. For example, the reference signal is a SSB or a CSI-RS. The UE may perform a random access procedure for the PSCell based on comparing the RSRP with a threshold.

In another embodiment, a MN may identify that a SCG is deactivated. The MN may receive, from the UE, a report of RRM measurements for the PSCell, while the SCG is deactivated. The MN may transmit, to a UE, information on a TCI state for a PSCell. The TCI state may be activated for a PDCCH or a PDSCH on the PSCell of the activated SCG. The MN may transmit, to the UE, information for activating the SCG. For example, the information for activating the SCG may include information on a downlink BWP to be activated for the PSCell upon activation of the SCG.

In another embodiment, a SN may identify that a SCG is deactivated. The SN may transmit, to a MN, information on a TCI state for a PSCell. The TCI state may be activated for a PDCCH or a PDSCH on the PSCell of the activated SCG. The SN may transmit, to the MN, information for activating the SCG. The SN may receive, from the MN, a report of the RRM measurements for the PSCell, the RRM measurement performed by the UE while the SCG is deactivated. The SM may receive, from the UE, a random access preamble on the PSCell upon activation of the SCG.

FIG. 6 is a diagram illustrating the structure of a UE according to an embodiment of the disclosure.

Referring to FIG. 6, the UE may include a transceiver 601, a controller 602, and a storage 603. However, the components of the UE are not limited to the above-described examples. For example, the UE may include more or fewer components than the aforementioned components. Further, the transceiver 601, the controller 602, and the storage 603 may be implemented in the form of a single chip. For example, the controller 602 may be defined as a circuit or application-specific integrated circuit or at least one processor.

The transceiver 601 may transmit and receive signals to and from another network entity. For example, the transceiver 601 may receive dedicated RRC signaling being broadcasted from a base station according to an embodiment of the disclosure. For example, the transceiver 601 may receive information including an indication to deactivate the SCG. For example, the transceiver 601 may receive information on a TCI state for a PSCell. For example, the transceiver 601 may receive information for activating the SCG. The information for activating the SCG may include information on a downlink BWP to be activated for the PSCell upon activation of the SCG.

The controller 602 may be configured to control operations of the UE according to embodiments (e.g., embodiment 1/2) and/or methods (e.g., methods 1-1/1-2/1-3/1-4/1-5/2-1/2-2) of the disclosure. For example, the controller 602 may control signal flow between respective blocks so as to perform an operation according to the above-described drawings and flowcharts. Specifically, the controller 602 may configured to identify that a SCG is deactivated. While the SCG is deactivated, the controller 602 may configured to perform RRM measurements for the PSCell and control the transceiver 601 to transmit a report of the RRM measurements to the MN. Upon activation of the SCG, the controller 602 may configured to measure a RSRP based on a reference signal on the PSCell, and perform a random access procedure for the PSCell based on comparing the RSRP with a threshold.

The storage 603 may store at least one of information being transmitted and received through the transceiver 601 and information being generated through the controller 602. In an embodiment, the storage comprises one or more memories.

FIG. 7 is a diagram illustrating the structure of a base station according to an embodiment of the disclosure.

Referring to FIG. 7, the base station may include a transceiver 701, a controller 702, and a storage 703. However, the components of the base station are not limited to the above-described examples. For example, the base station may include more or fewer components than the aforementioned components. Further, the transceiver 701, the controller 702, and the storage 703 may be implemented in the form of a single chip. For example, the controller 702 may be defined as a circuit or application-specific integrated circuit or at least one processor. For example, each of MN and SN may correspond to the base station.

The transceiver 701 may transmit and receive signals to and from another network entity. For example, the transceiver 701 may transmit information including an indication to deactivate the SCG. For example, the transceiver 701 may transmit information on a TCI state for a PSCell. For example, the transceiver 701 may transmit information for activating the SCG. The information for activating the SCG may include information on a downlink BWP to be activated for the PSCell upon activation of the SCG.

The controller 702 may be configured to control operations of the base station according to embodiments (e.g., embodiment 1/2) and/or methods (e.g., methods 1-1/1-2/1-3/1-4/1-5/2-1/2-2) of the disclosure. For example, the controller 702 may control signal flow between respective blocks so as to perform an operation according to the above-described drawings and flowcharts. Specifically, the controller 702 may configured to identify that a SCG is deactivated. While the SCG is deactivated, the controller 702 may configured to control the transceiver 701 to receive a report of the RRM measurements for the PSCell from the UE. Alternatively, the controller 702 may configured to control the transceiver 701 to receive, from the UE, a random access preamble on the PSCell upon activation of the SCG. The random access preamble may be received in case that a RSRP measured based on a reference signal on the PSCell is equal to or less than a threshold.

The storage 703 may store at least one of information being transmitted and received through the transceiver 701 and information being generated through the controller 702. In an embodiment, the storage comprises one or more memories.

In the above-described detailed embodiments of the disclosure, the elements included in the disclosure may be expressed in the singular or plural form depending on the proposed detailed embodiment. However, the singular or plural expression has been selected suitably for a situation proposed for convenience of description, and the disclosure is not limited to the singular or plural elements. Although an element has been expressed in the plural form, it may be configured in the singular form. Although an element has been expressed in the singular form, it may be configured in the plural form.

Meanwhile, although the detailed embodiments have been described in the detailed description of the disclosure, the disclosure may be modified in various ways without departing from the scope of the disclosure. Accordingly, the scope of the disclosure should not be limited to the above-described embodiments, but should be defined by not only the claims but also equivalents thereof.

1. A method performed by a user equipment (UE) in a wireless communication system supporting a dual connectivity, the method comprising:
identifying that a secondary cell group (SCG) is deactivated;
receiving first information on a transmission configuration information (TCI) state for a primary secondary cell (PSCell); and
receiving second information for activating the SCG,
wherein the TCI state is activated for a physical downlink control channel (PDCCH) or a physical downlink shared channel (PDSCH) on the PSCell of the SCG activated based on the second information.

2. The method of claim 1, further comprising:
measuring a reference signal received power (RSRP) based on a reference signal on the PSCell, upon activation of the SCG; and
performing a random access procedure for the PSCell based on comparing the RSRP with a threshold.

3. The method of claim 1, further comprising:
while the SCG is deactivated, performing radio resource management (RRM) measurements for the PSCell; and
transmitting, to a master node, a report of the RRM measurements.

4. The method of claim 1,
wherein the second information further includes information on a downlink bandwidth part (BWP) to be activated for the PSCell upon activation of the SCG.

5. The method of claim 4,
wherein the second information for activating the SCG is received via a radio resource control (RRC) signaling or a medium access control-control element (MAC-CE) signaling.

6. A method performed by a master node in a wireless communication system supporting a dual connectivity, the method comprising:
identifying that a secondary cell group (SCG) is deactivated;
transmitting, to a user equipment (UE), first information on a transmission configuration information (TCI) state for a primary secondary cell (PSCell); and
transmitting, to the UE, second information for activating the SCG,
wherein the TCI state is activated for a physical downlink control channel (PDCCH) or a physical downlink shared channel (PDSCH) on the PSCell of the SCG activated based on the second information.

7. The method of claim 6, further comprising:
receiving, from the UE, a report of radio resource management (RRM) measurements for the PSCell, while the SCG is deactivated.

8. The method of claim 6,
wherein the second information further includes information on a downlink bandwidth part (BWP) to be activated for the PSCell upon activation of the SCG, and
wherein the second information for activating the SCG is received via a radio resource control (RRC) signaling or a medium access control-control element (MAC-CE) signaling.

9. A method performed by a secondary node in a wireless communication system supporting a dual connectivity, the method comprising:
identifying that a secondary cell group (SCG) is deactivated;
transmitting, to a master node, first information on a transmission configuration information (TCI) state for a primary secondary cell (PSCell);
transmitting, to the master node, second information for activating the SCG,
wherein the TCI state is activated for a physical downlink control channel (PDCCH) or a physical downlink shared channel (PDSCH) on the PSCell of the SCG activated based on the second information.

10. The method of claim 9, further comprising:
receiving, from a user equipment (UE), a random access preamble on the PSCell upon activation of the SCG,
wherein the random access preamble is received in case that a reference signal received power (RSRP) measured based on a reference signal on the PSCell is equal to or less than a threshold.

11. The method of claim 9, further comprising:
receiving, from the master node, a report of the radio resource management (RRM) measurements for the PSCell, the RRM measurement performed by a user equipment (UE) while the SCG is deactivated,
wherein the second information further includes information on a downlink bandwidth part (BWP) to be activated for the PSCell upon activation of the SCG.

12. A user equipment (UE) in a wireless communication system supporting
a dual connectivity, the UE comprising:
a transceiver; and
a processor coupled with the transceiver and configured to:
identify that a secondary cell group (SCG) is deactivated,
receive first information on a transmission configuration information (TCI) state for a primary secondary cell (PSCell), and
receive second information for activating the SCG,
wherein the TCI state is activated for a physical downlink control channel (PDCCH) or a physical downlink shared channel (PDSCH) on the PSCell of the SCG activated based on the second information.

13. The UE of claim 12, wherein the processor is further configured to:
measure a reference signal received power (RSRP) based on a reference signal on the PSCell, upon activation of the SCG, and
perform a random access procedure for the PSCell based on comparing the RSRP with a threshold.

14. The UE of claim 12, wherein the processor is further configured to:
while the SCG is deactivated, perform radio resource management (RRM) measurements for the PSCell, and
transmit, to a master node, a report of the RRM measurements.

15. The UE of claim 12,
wherein the second information further includes information on a downlink bandwidth part (BWP) to be activated for the PSCell upon activation of the SCG.
